(19) United States
(12) Patent Application Publication
(10) Pub. No.: US 2026/0352615 A1
(43) Pub. Date: Nov. 5, 2026

(54) Electronic Communication Agents Using Large Language Models

(71) Applicant: Google LLC, Mountain View, CA (US)

(72) Inventors: Matthew Sharifi, Kilchberg (CH); Tony Mak, London (GB); David Karam, Los Gatos, CA (US)

(21) Appl. No.: 19/487,429

(22) PCT Filed: May 23, 2023
(86) PCT No.: PCT/US2023/023206

§ 371 Date: Nov. 24, 2025

(51) Int. Cl. H04L 51/02; G06F 16/3329; H04L 51/21; H04L 67/306

(52) U.S. Cl. CPC H04L 51/02; G06F 16/33295; H04L 51/21; H04L 67/306

(57) ABSTRACT

Systems and methods described herein are related to communication agents that can automatically handle incoming and outgoing electronic communications for users. An example computing system can receive an electronic communication from a second user and determine, using a large language model of the communication agent, whether or not to respond to the electronic communi-2024/242672 cation using the communication agent. The computing system, in response to determining to respond to the electronic communication, generates, using the large language model, a response to the electronic communication, and transmits the response to the second user. The computing system can also take other actions in response to receiving communications if it is determined not to respond to the communication.

### FIELD

The present disclosure relates generally to electronic communications, such as electronic mail. More particularly, the present disclosure relates to the use of large language models as assistants for performing automatic responses to certain electronic communications.

### BACKGROUND

Users of electronic communications, such as short message service (“SMS”) messages, electronic mail (“email”) messages, instant messaging, and the like can be subject to an overload of information typically received via software applications that handle these kinds of electronic communications. The user may be unable to respond to each and every electronic communication and may struggle to manage the volume of electronic communications received in various software applications.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for initializing a communication agent. The method includes receiving, by an electronic processor, an electronic communication from a user, the electronic communication being an initialization message for a communication agent and initializing, by the electronic processor, the communication agent, the communication agent comprising at least a first large language model. The method also includes determining, by the electronic processor, one or more profile settings of the user based on the received electronic communication using the first large language model of the communication agent, storing, by the electronic processor, the one or more profile settings of the user in memory associated with the communication agent, and receiving, by the electronic processor, an additional electronic communication from the user, the additional electronic communication including text from the user. The method further includes processing, by the electronic processor, the one or more profile settings of the user and the additional electronic communication using the first large language model of the communication agent, and updating, by the electronic processor, the one or more profile settings of the user based on the processing performed using the first large language model.

Another example aspect of the present disclosure is directed to a computing system for responding to an electronic communication. The computing system includes an electronic processor and a non-transitory, computer-readable medium comprising a communication agent associated with a first user, the communication agent comprising a large language model and one or more profile settings associated with the first user and instructions that, when executed by the electronic processor, cause the electronic processor to perform operations. The operations include receiving an electronic communication from a second user and determining, using the large language model of the communication agent, whether or not to respond to the electronic communication using the communication agent. The operations also include, in response to determining to respond to the electronic communication, generating, using the large language model, a response to the electronic communication, and transmitting the response to the second user.

Another example aspect of the present disclosure is directed to a non-transitory, computer-readable medium comprising a communication agent associated with a first user, the communication agent comprising a large language model and one or more profile settings associated with the first user and instructions that, when executed by an electronic processor, cause the electronic processor to perform operations. The operations include receiving an electronic communication from a second user and determining, using the large language model of the communication agent, whether or not to respond to the electronic communication using the communication agent. The operations also include, in response to determining to not respond to the electronic communication, determining, based on the electronic communication and the one or more profile settings for the user, an action to take for the electronic communication and generating instructions to perform the determined action.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example communication model according to example embodiments of the present disclosure.

FIG. 2 illustrates an example of an electronic communication for updating one or more profile settings according to example embodiments of the present disclosure.

FIG. 3 depicts a communication agent generating communications on behalf of a user according to example embodiments of the present disclosure.

FIG. 4 is a block diagram illustrating a decision making process for a communication agent according to example embodiments of the present disclosure.

FIG. 5 depicts a flow chart diagram of an example method for performing communication agent initialization according to example embodiments of the present disclosure.

FIG. 6 depicts a flow chart diagram of an example method for generating a response to an electronic communication using a communication agent according to example embodiments of the present disclosure.

FIG. 7 depicts a flow chart diagram of an example method for taking an action in response to an electronic communication using a communication agent according to example embodiments of the present disclosure.

FIG. 8A depicts a block diagram of an example computing system that controls communication agents according to example embodiments of the present disclosure.

FIG. 8B depicts a block diagram of an example computing device that controls communication agents according to example embodiments of the present disclosure.

FIG. 8C depicts a block diagram of an example computing device that controls communication agents according to example embodiments of the present disclosure.

Reference numerals that are repeated across plural figures are intended to identify the same features in various implementations.

### DETAILED DESCRIPTION

### Overview

Generally, the present disclosure is directed to an artificial intelligence (“AI”) system for generating automatic responses using a large language model (“LLM”). In particular, a communication agent (referred to herein as a “communication agent,” an “agent,” and the like), an instance of a learned model that is assigned to a particular user, can assist the user by triaging incoming electronic communications and, in some instances, providing automatic responses to certain electronic communications. For example, based on the content of a particular electronic communication or based on a situation associated with the user the agent is assigned to (e.g., the user is out of office or is traveling), the communication agent can automatically answer common questions received in electronic communications or perform simple actions on the behalf of the user. The user can have one or more communication agents associated with various accounts and/or software applications.

The user can initialize a communication agent by starting communications with the communication agent, such as sending the communication agent an electronic message containing certain details about the user. The details can include preferences for communications, preferred meeting times, information the communication agent should forward to the user, and the like. The communication agent runs the electronic communication through an instance of an LLM, which parses the contents of the message to confirm that the intent of the message is to provide details about the user to the communication agent and to extract a summarized, third-person version of the information from the electronic communication. This summary is then persisted in memory and illustrates what the communication agent “knows” about the user. The user may prompt the agent to provide the summary to them so that the user can see what the agent knows about the user.

The user can send subsequent electronic communications to the agent, and the agent can run the received communications through the same LLM to derive updates to the user profile persisted in memory. To do this, both the existing user profile information and the new electronic communication are provided to the LLM, which then outputs a new version of the user profile.

When a communication agent receives a message from another user or from its associated user but is not the only addressee (e.g., the user cc's the communication agent in on an email chain between the user and another user), the communication agent can consider this a prompt from the other user or from the associated user. To respond to the message, the agent is prompted with the summarized preferences in the user profile and then fed the incoming message as input. Based on the received message and/or the user profile, the LLM can decide whether or not to respond and, if it responds, how to formulate a proposed response in a conversational manner. This proposed response can then be sent from a communication address associated with the agent to the other user or the associated user.

In other cases, the agent can defer to the user it is associated with by, for example, forwarding or cc'ing the user on the electronic communication to solicit input on the communication if the LLM is unsure if the agent should respond or if it wants to route important information to the user at that moment. The agent can also choose to simply store electronic communications in storage for later access by the user.

In another example, the communication agent can choose to buffer information from electronic communications of a similar type (e.g., buffering a number of job postings received in a day or week) and send the buffered information/communications to the user in one message or summary message once a desired threshold number of communications having similar information is met or in response to the user sending a communication explicitly asking for an update on the topic (e.g., the user sending a message asking “is anyone buying my product from the website?”). This buffering preference can be provided by the user and/or later modified by the user.

Whether the agent responds to the message and the level of detail in the message generated by the LLM can depend on how familiar the communication agent is with the other user. Initially, the communication agent can assume that all other users are untrusted users, and can use a rule set for responding. Over time, the communication agent can learn from its user based on communications where the communication agent is cc'd on the electronic communication. For example, if the communication agent sees its user frequently communicating with another user and observes the information being shared with that other user, the communication agent can learn to replicate that behavior in the future.

In some examples, there may be multiple communication agents in a single electronic communication thread. For instance, the user might want to reach a consensus based decision with multiple other users and can choose to interface with their communication agents instead. In this setting, each of the communication agents handles incoming communications as normal. Other communication agents can respond in turn and will stop responding once consensus has been reached among the communication agents.

By utilizing communication agents, users can simply and streamline the handling of large amounts of electronic communications received in various software applications, and a machine-learned model can learn how the user communicates so that the machine-learned model (as the communication agent) can work on behalf of the user to automatically perform simple actions, such as responding to communications, scheduling meetings, and the like. The communication agent can also triage incoming information for the user. By leveraging the LLM, the communication agent has a much deeper understanding of user queries, and is enabled to generate very natural, conversational-style responses for the user.

The proposed communication agents can also be trusted by the user to respond on their behalf because of the use of the LLM and the use and constant updating of user preferences and knowledge that the communication agents have about the user(s) associated with each agent. Furthermore, as a stand-alone entity (e.g., not replying as the user but as a clear indication that the communication agent is an AI model), it can be clear to other users and the associated user when a communication agent has performed actions. Additionally, as a machine-learned model, the communication agent can learn user response patterns, user communication patterns, and other societal norms to seamlessly integrate into frequently used communication channels used by the user.

The proposed invention therefore can save hundreds or thousands of hours a user would spend on parsing information in communications, responding to communications, and otherwise triaging communications. Therefore, hours spent by the user that would lead to increased power usage, network bandwidth usage, and processing capability can be reduced or better managed while increasing the productivity and the efficiency of the user in communicating, especially when the user is otherwise predisposed and unable to handle the large amounts of electronic communications (e.g., when the user is traveling) coming through various communication software applications.

With reference now to the Figures, example embodiments of the present disclosure will be discussed in further detail.

### Example Communication Agents and Models

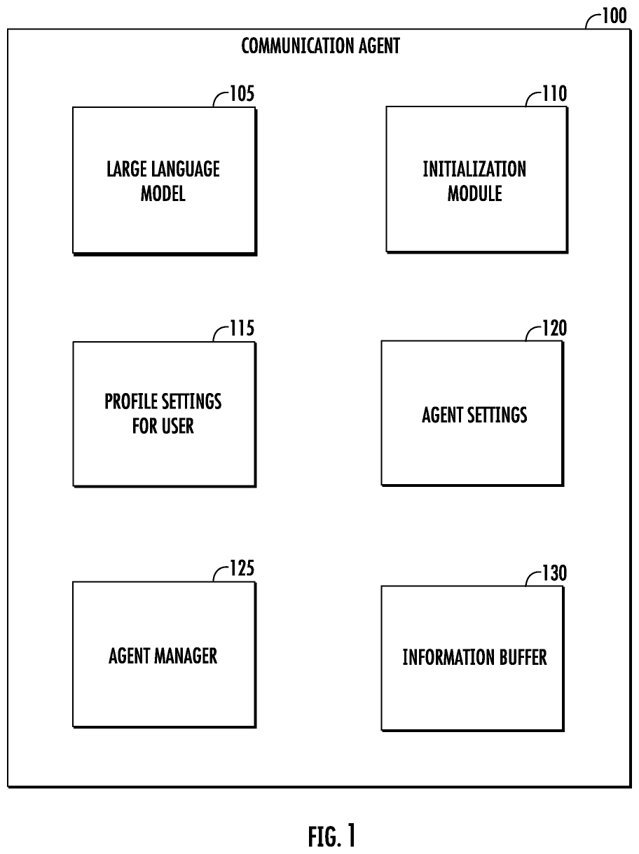

FIG. 1 depicts a block diagram of an example communication agent 100 according to example embodiments of the present disclosure. The communication agent 100 includes a large language model 105, an initialization module 110, one or more profile settings 115, agent settings 120, an agent manager 125, and an information buffer 130.

The large language model 105 can be a machine-learned model, such as a neural network, with multiple parameters that is trained on large quantities of unlabeled text using self-supervised learning. In some examples, the large language model 105 can be a deep learning model with multiple parameters that is a model for general language processing purposes, instead of being trained for one specific language analysis task. The large language model 105 can have a transformer architecture and can be trained in an unsupervised manner on unannotated text. In some embodiments, the large language model 105 can be LaMDA, PaLM, and other similar models.

The large language model 105 is generally configured (e.g. prompted, fine tuned or otherwise adapted) to analyze text in electronic communications (such as emails, text messages, instant messages, and the like) in view of various profile settings, such as the one or more profile settings 115. Based on the analysis, the large language model 105 can determine content of the electronic communication, can understand an intent of the electronic communication (e.g., to schedule a meeting, to ask about a project, to ask about other plans, and the like), and can generate socially appropriate natural language responses as text to the electronic communication. For example, in response to receiving an electronic communication asking “Can [User Name] meet tomorrow at 3 PM?” the large language model 105 can generate a response that states “Yes, [User Name] can meet at that time. I will add the meeting to [User Name]'s calendar.” The large language model 105 is configured to respond as an entity separate from the user associated with the communication agent 100 (e.g., to act as a digital assistant and the like).

Initialization module 110 performs operations to create the communication agent 100 for a user requesting the creation and initialization of the communication agent 100. For example, a user may send an electronic communication with the user's name, electronic communication address (e.g., an email address or mobile telephone number), and other preferences and settings outlined in the text of the electronic communication. These preferences and profile settings can include, among other things, preferences for communications the communication agent 100 should respond to, preferred meeting times/locations/modalities (such as online meetings, phone meetings, in person meetings, and the like), what information the communication agent 100 should forward to the user, what the communication agent 100 should or should not do on behalf of the user, and the like. These preferences and settings can be saved as the one or more profile settings 115. In some embodiments, the one or more profile settings 115 can be stored as textual information (e.g., a string stored with the value “Meeting Preference: virtual”) or as non-textual information. In further embodiments, the one or more profile settings 115 can be used as inputs for prompt-tuning the large language model 105, which includes adapting the large language model 105 by providing the one or more profile settings 115 as front-end prompts to the large language model 105. These prompts guide the large language model 105 to desired outputs without the need to retrain the large language model 105 or update any weights associated with the large language model 105. In other embodiments, the one or more profile settings 115 can be input into the large language model 105 in order to update the weights of the large language model 105 based on the values of the provided one or more profile settings 115.

In some implementations, the large language model 105 can be used by the initialization module 110 during initialization to parse the electronic communication sent by the user as the initialization message. Based on the results of the parsing of text in the electronic communication, the large language model 105 can identify one or more values for different settings of the one or more profile settings 115. Based on the identified values, the initialization module 110 can set the values of the one or more profile settings 115.

In some implementations, the initialization module 110 can use the large language model 105 to parse the contents of the initialization message to confirm the intent of the initialization message as providing information about the user to the communication agent 100. The initialization module 110 can also use the large language model 105 to generate a summarized, third-person version of the information parsed from the initialization message that can then be stored in memory associated with the communication agent 100 for later use by the communication agent 100.

The initialization module 110 can be accessed using any communication channel that the communication agent 100 supports (e.g., email, SMS, instant messaging, and the like). Furthermore, the initialization module 110 can be communication channel-agnostic. In other words, the initialization module 110 can be initiated from any supported communication channel for the communication agent 100 and, regardless of the communication used to initialize the communication agent 100, the communication agent 100 can use the information received during initialization to respond to communications on any other supported communication channel.

The agent settings 120 can include information about the communication agent 100 itself. For example, the agent settings 120 can include an electronic communication address for the communication agent 100 (e.g., “user_name@agent.domain.com”) to include the communication agent 100 on communications, an identity of an associated user for the communication agent 100, a software application or software applications the communication agent 100 is compatible with receiving communications from, and other settings associated with the communication agent 100.

The agent manager 125 is generally configured to handle input and output from the communication agent 100, perform certain processing for the communication agent 100, and interact with other components of the communication agent 100. For example, the agent manager 125 can receive electronic communications for the communication agent 100 from the associated user or other users and direct the electronic communications to the large language model 105 for processing. The agent manager 125 can also handle outputs from the large language model 105, such as receiving electronic communications composed by the large language model 105 as responses to received communications and transmitting these responses to the user who originally sent the electronic communication. In some implementations, the agent manager 125 can also receive other outputs from the large language model 105, such as a confidence score that the electronic communication should be responded to, a determined intent of the electronic communication, decisions on whether or not to respond to electronic communications, and the like. Based on these received outputs, the agent manager 125 can perform different actions. For example, if the large language model 105 determines that it is unsure whether or not to respond to the received electronic communication, the agent manager 125 can forward the electronic communication to the associated user for review and receive feedback from the associated user regarding whether the user will handle the communication or if the communication agent 100 should handle the communication. In some implementations, the agent manager 125 can also further train the large language model 105 based on the feedback received from the user.

In some implementations, the agent manager 125 can perform comparisons of confidence scores to confidence thresholds. For example, if the large language model 105 determines with 60% confidence that an electronic communication should be responded to by the communication agent 100, the agent manager 125 can compare that confidence score to a known confidence threshold needed to actually send a response. If the confidence score meets or exceeds the confidence threshold, the agent manager 125 can send a response generated by the large language model 105 back to the user who sent the electronic communication. If the confidence score does not meet or exceed the confidence threshold, the agent manger 125 will not send a response and may instead take other actions, such as forwarding the communication to the associated user.

In some implementations, the agent manager 125 can receive a message intent associated with the electronic communication from the large language model 105. For example, the large language model 105 can determine that the intent of a communication is to schedule a meeting with the associated user. Based on this received intent, the agent manager 125 can generate instructions for the large language model 105 to create a meeting invite based on the received electronic communication. The agent manager 125 can then send the meeting invite to the user who originally sent the electronic communication and add the meeting invite to a calendar associated with the associated user for the communication agent 100.

In some implementations, the agent manager 125 can determine that a received electronic communication is from the associated user of the communication agent 100. When communications are received from the associated user and do not include other addressees, the agent manager 125 can determine that the user is communicating exclusively with the communication agent 100. When the user is communicating exclusively with the communication agent 100, received electronic communications can be analyzed by the agent manager 125 to determine actions to take. For example, the agent manager 125 can provide the electronic communication to the large language model 105 to determine the intent of the user. Based on the user intent, an action can be performed. In one example, the intent of the electronic communication can be to update one or more of the one or more profile settings 115. In this example, the agent manager 125 provides the electronic communication and the one or more profile settings 115 to the large language model 105, which derives an update for the one or more profile settings 115 based on the received electronic communication. The derived update is provided to the agent manager 125 as an updated set of the one or more profile settings 115, and the agent manager 125 then saves the updated set of the one or more profile settings 115 as the one or more profile settings 115.

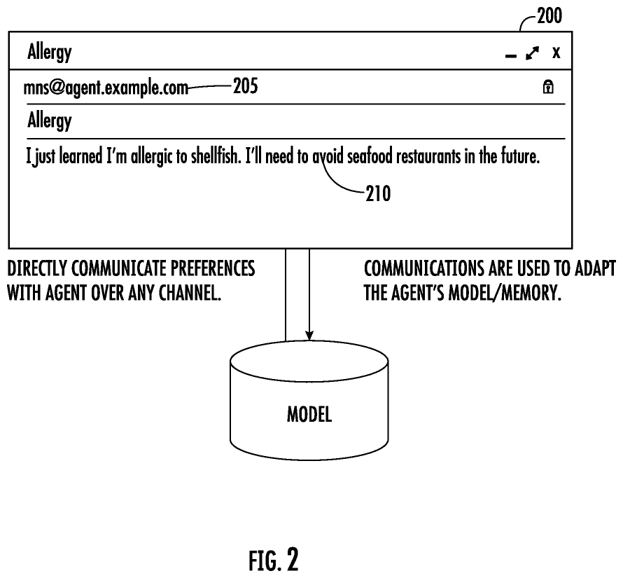

FIG. 2 illustrates an example of an electronic communication 200 for updating one or more settings of the one or more profile settings 115. The user sends the electronic communication 200 to the electronic communication address 205 associated with the communication agent 100 along with information 210 as text in the electronic communication 200. The agent manager 125 receives this electronic communication 200 and provides it to the large language model 105 for parsing and analysis. The agent manager 125 receives an output from the large language model 105 that the electronic communication 200 intends to update the one or more profile settings 115 for the associated user. The agent manager 125 then generates instructions for the large language model 105 to take both the one or more profile settings 115 (as text) and the electronic communication 200 and generate a new set of the one or more profile settings 115 with a derived update to the one or more profile settings 115 based on the information 210 contained in the electronic communication 200. The agent manager 125 then receives an updated set of the one or more profile settings 115 and saves this updated set as the one or more profile settings 115.

In another example, the large language model 105 can identify the intent of the electronic communication to be a request for the communication agent 100 to inform the user of what values are currently in place for the one or more profile settings 115. In this example, the agent manager 125 receives a request from the associated user in the form of an electronic communication that includes text indicating the associated user wishes to learn what the communication agent 100 “knows” about the associated user. The agent manager 125 provides the electronic communication to the large language model 105 which identifies the electronic communication as a request to learn what the communication agent 100 “knows” about the associated user. The agent manager 125 then provides the one or more profile settings 115 to the user in the form of text in an electronic communication.

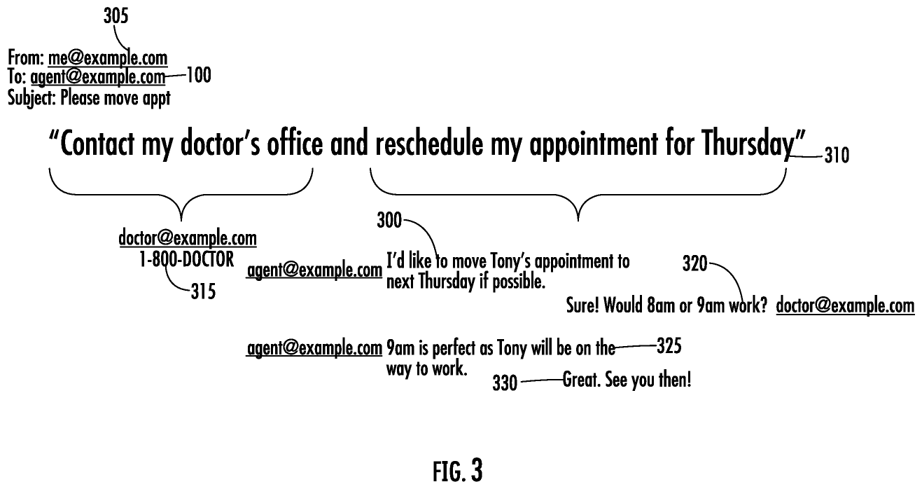

In some implementations, the large language model 105 can be used to generate communications on behalf of the user. For example, FIG. 3 illustrates the communication agent 100 generating a communication 300 on behalf of a user 305. In the illustrated example, the communication agent 100 receives a received communication 310 from the user 305 asking the communication agent 100 to contact the physician of the user 305 to reschedule an appointment. The communication agent 100 can use the large language model 105 to process the received communication 305 to determine the intent of the user 305. The communication agent 100 can also access the one or more profile settings 115 to determine, for example, the email address 315 of the physician. The communication agent 100 then uses the large language model 105 to generate the communication 300 based on the one or more profile settings 115 and the received communication 310. The communication 300 can include content that a human being would type out when contacting their physician to reschedule an appointment, such as saying “I'd like to move [name of the user]'s appointment to next Thursday if possible.” The communication agent 100 communicates in the third person to make it clear to the receiving party that the communication agent 100 is communicating not as the user 305 but on behalf of the user 305. The communication agent 100 then sends the communication 300 to the email address 315 of the physician.

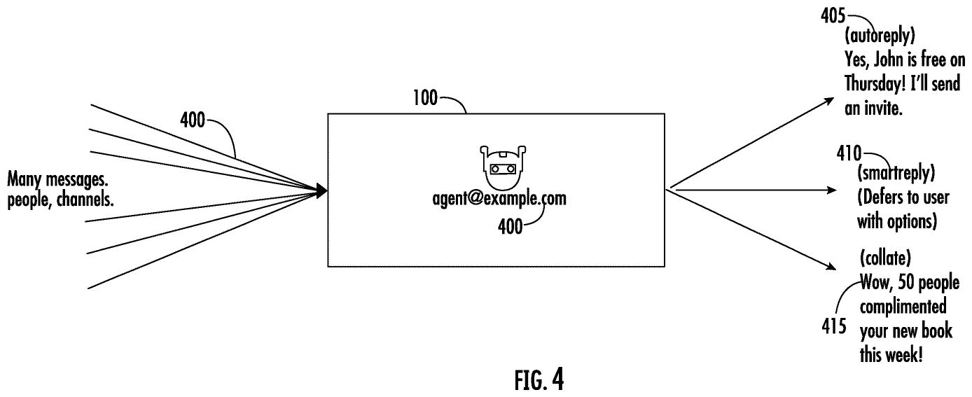

The communication agent 100 can also generate responses to communications from users other than the user associated with the communication agent 100. For example, communication agent 100 can receive responsive communication 320 from the physician of the user 305. As illustrated in FIG. 3, the responsive communication 320 includes a response to the originally sent communication 300. However, in other embodiments, the communication agent 100 can monitor other various input channels and respond to incoming communications directed to the user associated with the communication agent 100 without needing to initiate a conversation. Additional details regarding responding to communications can be found below with regards to FIG. 4.

After receiving the responsive communication 320, the communication agent 100 can use the large language model 105 to process the text of the responsive communication 320 to determine the intent of the responsive communication 320. This intent can then be compared to a relevant setting of the one or more profile settings 115 or to another software application, database, spreadsheet, or other data repository to generate a follow-up message 325. For example, in FIG. 3, the communication agent 100 receives the responsive communication 320 and uses the large language model 105 to determine that the intent of the responsive communication is to reschedule the appointment. The communication agent 100 can then compare the noted times for rescheduling the appointment to a preferred time setting in the one or more profile settings 115, to a calendar software application associated with the user, or another data repository to determine how to respond to the responsive message 320. After determining how to respond, the communication agent 100 can generate the follow-up message 325.

In some embodiments, the communication agent 100 may receive a confirmation message 330 confirming that the follow-up message 325 was received. The confirmation message 330 may include further information related to the conversation or, as illustrated in FIG. 3, can simply be a confirmation. In other embodiments, the confirmation message 330 may include other relevant content.

Using the large language model 105, the communication agent 100 can determine whether or not to respond to the confirmation message 330 and continue the conversation (if necessary) or, as shown in FIG. 3, determine that the conversation has ended and choose not to respond. Additional details regarding determining how the communication agent 100 chooses to respond or not can be found below with regards to FIG. 4.

FIG. 4 is a block diagram illustrating a decision making process for the communication agent 100 according to example embodiments of the present disclosure. As mentioned, the communication agent 100 can handle communications from various channels 400, such as from SMS messages, e-mail, instant messages, private messages sent through software applications with chat or messaging features, and other communication channels.

The communication agent 100 can determine not only the content of responses but also how and when to respond to communications received by the electronic communication address associated with the communication agent 100. This determination can include providing the one or more profile settings 115 and a received electronic communication to the large language model 105. Based on the received electronic communication and the one or more profile settings 115, the communication agent 100 can determine an intent of the electronic communication using the large language model 105. For example, the communication agent 100 can determine that the electronic communication is an informational message sent to the user, that the electronic communication is a direct query to the user, that the electronic communication is spam or other types of bulk electronic communications, and the like. Furthermore, the communication agent 100 can determine a specific intent of the electronic communication, such as the electronic communication being a request by another user to schedule a meeting, the electronic communication being a company-wide message informing all users of an update to a policy, and the like.

Based on the determined intent of the electronic communication, the communication agent 100 can then determine if the electronic communication is a communication to be handled by the communication agent 100. For example, if the received communication is only an informational communication that does not require a response or any other further action, the communication agent 100 can determine to take no action and to simply leave the electronic communication for the user to read at their convenience. In other examples, the communication agent 100 can determine to respond to the electronic communication if the electronic communication requires a response and/or the one or more profile settings 115 indicate that the communication agent 100 can or should be responding to the communication based on the intent of the electronic communication. If the communication agent 100 determines it should respond to the communication, the communication agent 100 can use the one or more profile settings 115, the intent of the communication, and the text of the communication as inputs into the large language model 105 to generate response 405.

In some examples, the communication agent 100 can determine a level of detail to use in generating a response to the electronic communication. The level of detail in the generated response sets the tone of the response and also secures a level of privacy for the user. For example, the communication agent 100 can make a determination of an identity of a user who sent the electronic communication by, for example, comparing an electronic communication address associated with the communication to a known list of addresses that are “familiar” to the user associated with the communication agent 100, such as a list of co-workers, managers, family, friends, and other acquaintances. In other examples, the communication agent 100 can use prior history of the user communicating with the electronic communication address to determine how familiar the user is with the sender of the electronic communication. Based on this level of familiarity, the large language model 105 can select specific language to respond. For example, if the user is not familiar with the electronic communication address used to send the electronic communication, the generated response from the large language model 105 can include more formal terms and less personal details associated with the user, such as responding to a communication asking to schedule a meeting with “[User Name] is busy at that time. Would [alternative time] be acceptable?” In a contrasting example, if the user is familiar with the sender of the electronic communication, the generated response from the large language model 105 can be something like “Hi [Sender]. [User Name] has a meeting scheduled with [Manager Name] at that time, but would a different time work?” In this way, the large language model 105 can control the tone of the response to match the familiarity level at which the user would actually have a conversation with the sender. In some examples, the level of familiarity and, therefore, the level of detail can be determined using a trust factor associated with the sender of the message, where the trust factor represents numerically or by some other discrete value a level of trust or familiarity in the sender. This trust factor can be compared to a number of thresholds and, based on the comparisons, a level of detail for the response can be selected.

In some examples, the communication agent 100 can take actions other than responding to the electronic communication. For example, based on the one or more profile settings 115, the intent or the text of the electronic communication, and/or other factors, the communication agent 100 can take an action such as forwarding (using the same communication channel as the received message or using a different communication channel) 410 the electronic communication to the user asking if and how the communication agent 100 should respond and/or what actions the communication agent 100 should take based on the received electronic message. The user can indicate how the communication agent 100 should or should not handle the electronic communication. Based on the received indication from the user, the communication agent 100 can a) take the indicated action (e.g., responding or another action) and b) use the user indication to further train the large language model 105 for future instances where messages similar to the electronic communication are received. This further training can include modifying the large language model 105 itself (e.g., using the indication as training data with the indicated action as the desired outcome and the text of the electronic communication as the input data) or to modify one or more settings of the one or more profile settings 115 for future responses.

The further actions that can be taken can include a variety of actions, such as the illustrated example of collating 415 of messages that have similar intents and/or text into the information buffer 130 and then sending a generated message associated with the collated messages once a threshold is reached, such as the illustrated “Wow, 50 people complimented your new book this week!” message. Other actions can include, but are not limited to, scheduling a meeting using a calendar software application, generating a note in a note-taking application, generating a link to a video conference meeting using a video conference software application, updating one or more values of the one or more profile settings 115, generating a draft response for review by the user using an electronic communication software application, and the like.

In some examples, the communication agent 100 can determine a confidence score associated with the electronic communication. The confidence score indicates how confident the large language model 105 is that a certain action should be taken based on the intent and the text of the received communication. For example, the communication agent 100 can determine a confidence score that the electronic communication is a communication that should be handled by the communication agent 100 (e.g., responded to or another action taken based on the reception of the electronic communication). This confidence score can then be compared to a confidence threshold, which can be automatically defined or manually defined by the user. Based on the comparison of the confidence score to the confidence threshold, the large language model 105 can determine whether or not to take action in response to receiving the electronic communication.

### Example Methods

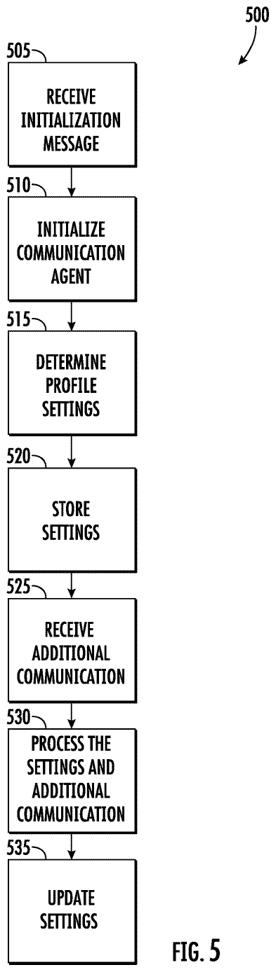

FIG. 5 depicts a flow chart diagram of an example method 500 for performing communication agent initialization according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 505, a computing system receives an electronic communication from a user, the electronic communication being an initialization message for a communication agent. In some examples, the electronic communication includes text from the user, and the text includes language indicating a value for at least profile setting of one or more profile settings.

At 510, the computing system initializes the communication agent, such as communication agent 100. The communication agent includes a large language model for interpreting text.

At 515, the computing system determines one or more profile settings of the user based on the received electronic communication using the large language model of the communication agent. For example, based on the text of the electronic communication, the large language model can determine values for the one or more profile settings and/or determine what types of settings should be stored for the user. This can be accomplished by, for example, parsing the received electronic communication using the large language model, confirming an intent of the message as being intended to provide information about the user to the communication agent, and then extracting a summarized, third-person version of the information received in the electronic communication to store as the one or more user settings. The information can include personal information about the user (e.g., name of the user and other information) and/or communication preferences of the user (e.g., if the user wants the communication agent to respond to meeting invites, types of communications that the communication agent should not respond to, and the like).

At 520, the computing system stores the one or more profile settings of the user in memory associated with the communication agent. The stored one or more profile settings can include the summarized, third-person version of the information from the communication.

In some examples, the computing system can generate a response message indicating that the one or more profile settings have been stored and can transmit the response to an electronic communication account (e.g., email, SMS messaging, and the like).

At 525, the computing system receives an additional electronic communication from the user, the additional electronic communication including text from the user.

At 530, the computing system processes the one or more profile settings of the user and the additional electronic communication using the large language model of the communication agent. This processing can be performed by, for example, providing the one or more profile settings as text to the large language model and providing the additional electronic communication to the large language model. The large language model processes these inputs to derive an update for the one or more user profile settings that is indicated in the additional electronic communication. For example, the one or more profile settings can include a setting “Respond to Meeting Invites from Colleagues” with a current value of “Yes, always” and the additional electronic communication can include text that states “I no longer want to always respond to meeting invites from colleagues. Instead, only respond if it is a manager.” The large language model determines that the user wishes to change the value of “Respond to Meeting Invites from Colleagues” from “Yes, always” to “Only if they are a manager,” which is then determined to be the derived update. However, because the large language model is a large language model, it is not necessarily required that the one or more profile settings be stored as key-value pairs. In some embodiments, natural language can simply be stored (e.g., “I don't like appointments on Tuesdays”) as the one or more profile settings, and the large language model can update, add, delete, and the like to these natural language values instead of updating key-value pairs.

At 535, the computing system updates the one or more profile settings of the user based on the processing performed using the large language model. For example, a setting can be changed, added, or removed.

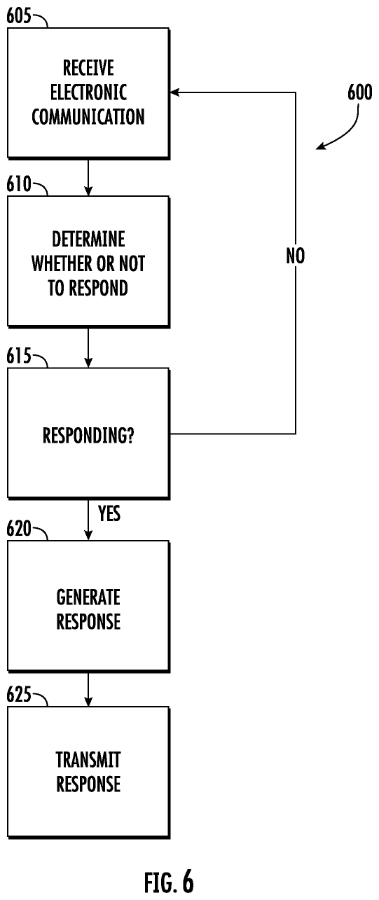

FIG. 6 depicts a flow chart diagram of an example method 600 for generating a response to an electronic communication using a communication agent according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 605, a computing system receives an electronic communication from a user not associated with an initialized communication agent. The electronic communication is addressed to the communication agent and is intended for the user associated with the communication agent.

At 610, the computing system determines, using a large language model of the communication agent, whether or not to respond to the electronic communication using the communication agent. This can include providing one or more profile settings associated with the user and the electronic communication to the large language model for processing. The large language model can then determine an intent of the electronic communication based on the profile settings and the text of the electronic communication. The large language model then determines if the electronic communication is a query to be handled by the communication agent based on the intent. In some examples, the large language model can determine that the electronic communication is a query to be handled by the communication agent by determining a confidence score associated with the communication and comparing the confidence score to a confidence threshold. Based on the comparison, the communication agent can then determine how to proceed (e.g., by responding). In some embodiments, the large language model can also be trained based on the comparison of the confidence score to the threshold.

At 615, the computing system determines whether or not to respond based on the determination performed in 610. In response to determining not to respond (“No” at 615), the communication agent takes no action and awaits further communications. In response to determining to respond to the electronic communication (“Yes” at 615), the computing system generates, using the large language model, a response to the electronic communication (at 620). In some examples, the content of the response can be determined using a determined level of detail based on the identity of the sender of the electronic communication, content of the electronic communication, and one more of the profile settings associated with the user. In some embodiments, the level of detail can be determined based on a trust factor associated with the identity of the sending user.

At 625, the computing system transmits the response to the sender.

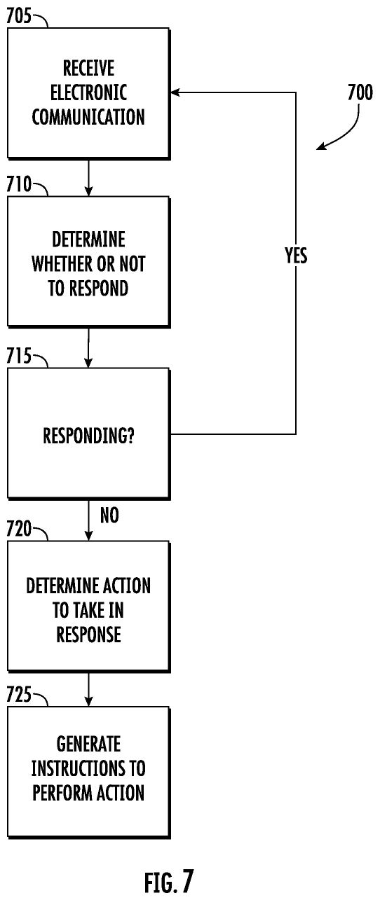

FIG. 7 depicts a flow chart diagram of an example method 700 for taking an action in response to an electronic communication using a communication agent according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 705, a computing system receives an electronic communication from a user not associated with an initialized communication agent. The electronic communication is addressed to the communication agent and is intended for the user associated with the communication agent.

At 710, the computing system determines, using a large language model of the communication agent, whether or not to respond to the electronic communication using the communication agent. This can include providing one or more profile settings associated with the user and the electronic communication to the large language model for processing. The large language model can then determine an intent of the electronic communication based on the profile settings and the text of the electronic communication. The large language model then determines if the electronic communication is a query to be handled by the communication agent based on the intent. In some examples, the large language model can determine that the electronic communication is a query to be handled by the communication agent by determining a confidence score associated with the communication and comparing the confidence score to a confidence threshold. Based on the comparison, the communication agent can then determine how to proceed (e.g., by taking one or more actions). In some embodiments, the large language model can also be trained based on the comparison of the confidence score to the threshold.

At 715, the computing system determines whether or not to respond based on the determination performed in 710. In response to determining to respond (“Yes” at 715), the communication agent takes no action and awaits further communications. In response to determining to not respond to the electronic communication (“No” at 715), the computing system determines one or more actions to take (at 720). In some examples, based on the received electronic communication and the one or more profile settings, the computing system can determine to forward the electronic communication to an electronic communication address associated with the user associated with the communication agent. In other examples, the computing system can determine that the electronic communication is a communication that contains information to be buffered, such as in an information buffer of the communication agent. In response to a summary condition being met (e.g., a certain time period elapses or a number of messages stored in the information buffer reaches a threshold), the computing system can generate a summary message describing the information stored in the information buffer and transmit the summary message to an electronic communication address associated with the user associated with the communication agent.

At 725, the computing system generates instructions to perform the determined action. After the instructions are generated, the instructions can be executed to execute the action for the electronic communication.

### Example Devices and Systems

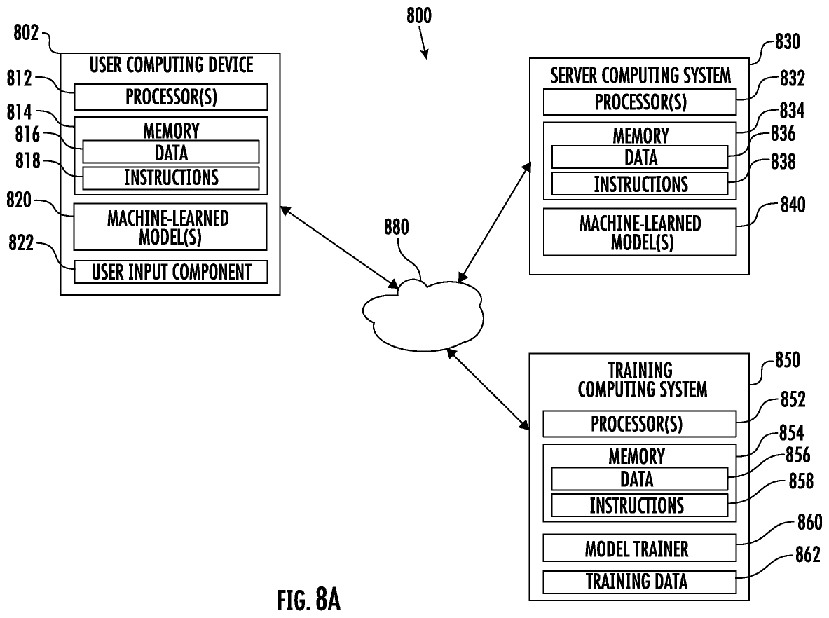

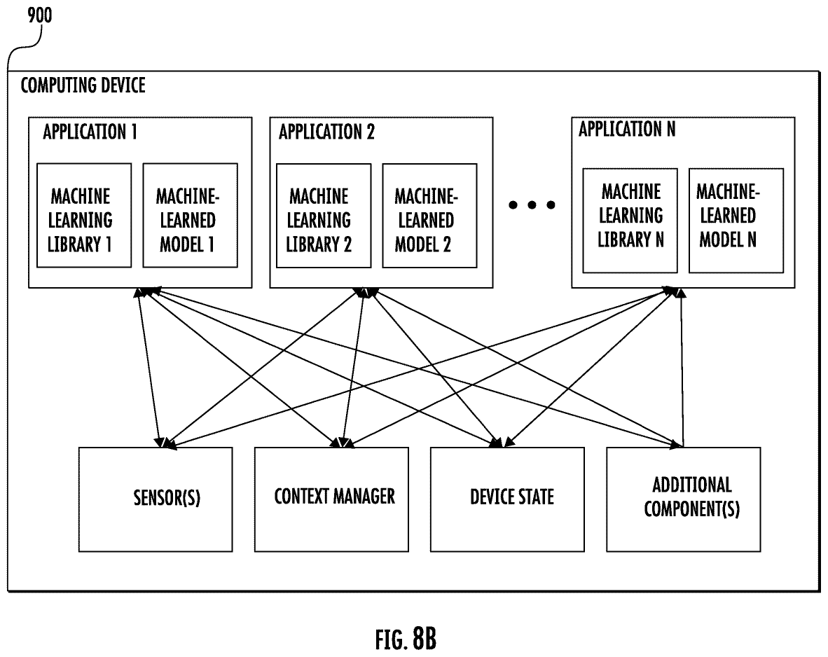

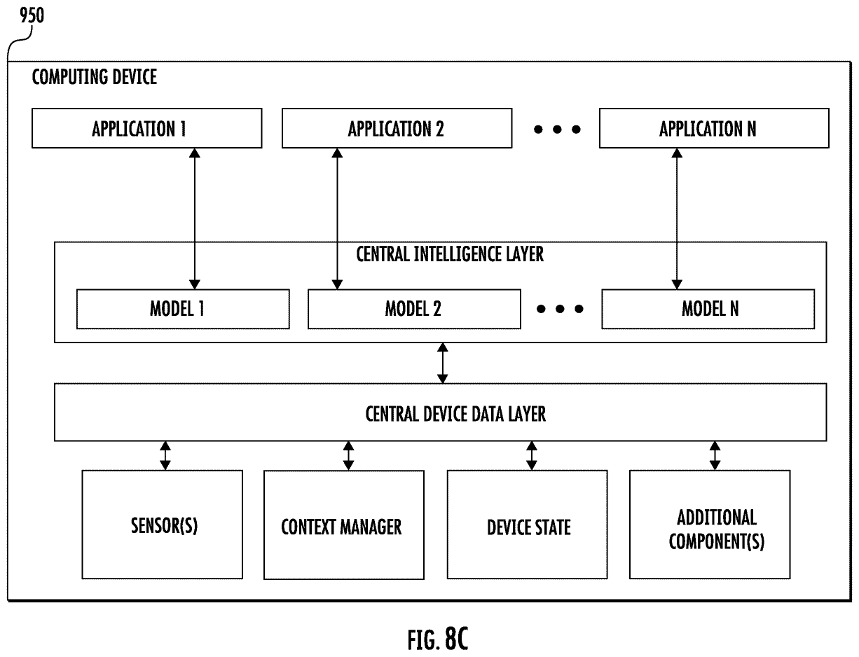

FIG. 8A depicts a block diagram of an example computing system 800 that controls communication agents according to example embodiments of the present disclosure. The system 800 includes a user computing device 802, a server computing system 830, and a training computing system 850 that are communicatively coupled over a network 880.

The user computing device 802 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 802 includes one or more processors 812 and a memory 814. The one or more processors 812 can be any suitable processing device (e.g., a processor core, a microprocessor, an ASIC, an FPGA, a controller, a microcontroller, etc.) and can be one processor or a plurality of processors that are operatively connected. The memory 814 can include one or more non-transitory computer-readable storage media, such as RAM, ROM, EEPROM, EPROM, flash memory devices, magnetic disks, etc., and combinations thereof. The memory 814 can store data 816 and instructions 818 which are executed by the processor 812 to cause the user computing device 802 to perform operations.

In some implementations, the user computing device 802 can store or include one or more large language models 820. For example, the large language models 820 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example large language models 820 are discussed with reference to FIGS. 1-4.

In some implementations, the one or more large language models 820 can be received from the server computing system 830 over network 880, stored in the user computing device memory 814, and then used or otherwise implemented by the one or more processors 812. In some implementations, the user computing device 802 can implement multiple parallel instances of a single large language model 820 (e.g., to perform parallel large language processing across multiple instances of large language models).

More particularly, the large language model 820 is generally configured to analyze text in electronic communications (such as emails, text messages, instant messages, and the like) in view of various profile settings, such as the one or more profile settings. Based on the analysis, the large language model 820 can determine content of the electronic communication, can understand an intent of the electronic communication (e.g., to schedule a meeting, to ask about a project, to ask about other plans, and the like), and can generate socially appropriate natural language responses as text to the electronic communication. For example, in response to receiving an electronic communication asking “Can you meet tomorrow at 3 PM?” the large language model 105 can generate a response that states “Yes, [User Name] can meet at that time. I will add the meeting to [User Name]'s calendar.” The large language model 820 is configured to respond as an entity separate from the user associated with the communication agent (e.g., to act as a digital assistant and the like).

Additionally or alternatively, one or more large language models 840 can be included in or otherwise stored and implemented by the server computing system 830 that communicates with the user computing device 802 according to a client-server relationship. For example, the large language models 840 can be implemented by the server computing system 840 as a portion of a web service (e.g., a communication processing service). Thus, one or more models 820 can be stored and implemented at the user computing device 802 and/or one or more models 840 can be stored and implemented at the server computing system 830.

The user computing device 802 can also include one or more user input components 822 that receives user input. For example, the user input component 822 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 830 includes one or more processors 832 and a memory 834. The one or more processors 832 can be any suitable processing device (e.g., a processor core, a microprocessor, an ASIC, an FPGA, a controller, a microcontroller, etc.) and can be one processor or a plurality of processors that are operatively connected. The memory 834 can include one or more non-transitory computer-readable storage media, such as RAM, ROM, EEPROM, EPROM, flash memory devices, magnetic disks, etc., and combinations thereof. The memory 834 can store data 836 and instructions 838 which are executed by the processor 832 to cause the server computing system 830 to perform operations.

In some implementations, the server computing system 830 includes or is otherwise implemented by one or more server computing devices. In instances in which the server computing system 830 includes plural server computing devices, such server computing devices can operate according to sequential computing architectures, parallel computing architectures, or some combination thereof.

As described above, the server computing system 830 can store or otherwise include one or more large language models 840. For example, the models 840 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 840 are discussed with reference to FIGS. 1-4.

The user computing device 802 and/or the server computing system 830 can train the models 820 and/or 840 via interaction with the training computing system 850 that is communicatively coupled over the network 880. The training computing system 850 can be separate from the server computing system 830 or can be a portion of the server computing system 830.

The training computing system 850 includes one or more processors 852 and a memory 854. The one or more processors 852 can be any suitable processing device (e.g., a processor core, a microprocessor, an ASIC, an FPGA, a controller, a microcontroller, etc.) and can be one processor or a plurality of processors that are operatively connected. The memory 854 can include one or more non-transitory computer-readable storage media, such as RAM, ROM, EEPROM, EPROM, flash memory devices, magnetic disks, etc., and combinations thereof. The memory 854 can store data 856 and instructions 858 which are executed by the processor 152 to cause the training computing system 850 to perform operations. In some implementations, the training computing system 850 includes or is otherwise implemented by one or more server computing devices.

The training computing system 850 can include a model trainer 860 that trains the machine-learned models 820 and/or 840 stored at the user computing device 802 and/or the server computing system 830 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 860 can perform a number of generalization techniques (e.g., weight decays, dropouts, etc.) to improve the generalization capability of the models being trained.

In particular, the model trainer 860 can train the large language models 820 and/or 840 based on a set of training data 862. The training data 862 can include, for example, unlabeled text that is learned through self-supervised learning. For example, the large language models 820 and/or 840 can be trained using a transformer architecture that maximizes the probability assigned to the next word in the training data given previous context (a left-to-right transformer) or by assigning a probability distribution over words given access to both preceding and following text (a bi-directional transformer). In addition to training the large language models 820 and/or 840 to predict the next word or to fill in the blank, the large language models 820 and/or 840 can be trained on other tasks to test the understanding of the data distribution, such as by predicting an entire next sentence, by providing (for example) pairs of sentences to the large language models 820 and/or 840 to predict whether the sentence appear side by side in a training corpus.

In some implementations, if the user has provided consent, the training examples can be provided by the user computing device 802. Thus, in such implementations, the model 820 provided to the user computing device 802 can be trained by the training computing system 850 on user-specific data received from the user computing device 802. In some instances, this process can be referred to as personalizing the model.

The model trainer 860 includes computer logic utilized to provide desired functionality. The model trainer 860 can be implemented in hardware, firmware, and/or software controlling a general purpose processor. For example, in some implementations, the model trainer 860 includes program files stored on a storage device, loaded into a memory and executed by one or more processors. In other implementations, the model trainer 860 includes one or more sets of computer-executable instructions that are stored in a tangible computer-readable storage medium such as RAM, hard disk, or optical or magnetic media.

The network 880 can be any type of communications network, such as a local area network (e.g., intranet), wide area network (e.g., Internet), or some combination thereof and can include any number of wired or wireless links. In general, communication over the network 880 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 8A illustrates one example computing system that can be used to implement the present disclosure. Other computing systems can be used as well. For example, in some implementations, the user computing device 802 can include the model trainer 860 and the training dataset 862. In such implementations, the models 820 can be both trained and used locally at the user computing device 802. In some of such implementations, the user computing device 802 can implement the model trainer 860 to personalize the models 820 based on user-specific data.

FIG. 8B depicts a block diagram of an example computing device 900 that controls communication agents according to example embodiments of the present disclosure. The computing device 900 can be a user computing device or a server computing device.

The computing device 900 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 8B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 8C depicts a block diagram of an example computing device 950 that performs according to example embodiments of the present disclosure. The computing device 950 can be a user computing device or a server computing device.

The computing device 950 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 8C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 950.

The central intelligence layer can communicate with a central device data layer. The central device data layer can be a centralized repository of data for the computing device 950. As illustrated in FIG. 8C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for initializing a communication agent, the method comprising:
receiving, by an electronic processor, an electronic communication from a user, the electronic communication being an initialization message for a communication agent;
initializing, by the electronic processor, the communication agent, the communication agent comprising at least a first large language model;
determining, by the electronic processor, one or more profile settings of the user based on the received electronic communication using the first large language model of the communication agent;
storing, by the electronic processor, the one or more profile settings of the user in memory associated with the communication agent;
receiving, by the electronic processor, an additional electronic communication from the user, the additional electronic communication including text from the user;
processing, by the electronic processor, the one or more profile settings of the user and the additional electronic communication using the first large language model of the communication agent; and
updating, by the electronic processor, the one or more profile settings of the user based on the processing performed using the first large language model.

2. The computer-implemented method of claim 1, wherein the electronic communication comprises text from the user, and wherein the text includes language indicating a value for at least profile setting of the one or more profile settings.

3. The computer-implemented method of claim 1, wherein the one or more profile settings includes at least one of personal information about the user and a communication preference for the user.

4. The computer-implemented method of claim 1, wherein determining the one or more profile settings of the user comprises:
parsing, with the first large language model, the received electronic communication;
confirming, with the first large language model, the intent of the received electronic communication is to provide information about the user to the communication agent; and
extracting, with the first large language model, a summarized, third-person version of the information from the received electronic communication.

5. The computer-implemented method of claim 4, wherein storing the one or more profile settings comprises storing the summarized, third-person version of the information as the one or more profile settings.

6. The computer-implemented method of claim 1, further comprising
generating, by the electronic processor, a response message from the communication agent indicating what has been stored as the one or more profile settings of the user; and
transmitting, by the electronic processor, the response message to an electronic communication account associated with the user.

7. The computer-implemented method of claim 1, wherein
processing the one or more profile settings of the user and the additional electronic communication using the first large language model of the communication agent comprises
providing, by the electronic processor, the one or more profile settings of the user as text to the first large language model;
providing, by the electronic processor, the additional electronic communication to the first large language model;
deriving, by the electronic processor, an update to the one or more profile settings of the user based on analysis performed by the first large language model on the one or more profile settings and the additional electronic communication; and
generating, by the electronic processor, new one or more profile settings based on the update; and
updating the one or more profile settings comprises
storing the new one or more profile settings in the memory associated with the communication agent as the one or more profile settings.

8. A computing system for responding to an electronic communication, the computing system comprising:
an electronic processor; and
a non-transitory, computer-readable medium comprising
a communication agent associated with a first user, the communication agent comprising a large language model and one or more profile settings associated with the first user; and
instructions that, when executed by the electronic processor, cause the electronic processor to perform operations, the operations comprising:
receiving an electronic communication from a second user;
determining, using the large language model of the communication agent, whether or not to respond to the electronic communication using the communication agent;
in response to determining to respond to the electronic communication
generating, using the large language model, a response to the electronic communication; and
transmitting the response to the second user.

9. The computing system of claim 8, wherein determining whether or not to respond to the electronic communication using the communication agent comprises
providing the one or more profile settings and the electronic communication to the large language model of the communication agent;
determining an intent of the electronic communication using the large language model based on the one or more profile settings and the electronic communication; and
determining if the electronic communication from the second user is a query to be handled by the communication agent based on the determined intent.

10. The computing system of claim 9, wherein determining whether or not to respond to the electronic communication comprises
determining to respond to the electronic communication when the electronic communication is determined to be a query to be handled by the communication agent.

11. The computing system of claim 10, wherein determining if the electronic communication from the second user is a query to be handled by the communication agent further comprises
determining a confidence score for response based on the electronic communication, the one or more profile settings, and the determined intent; and
determining the electronic communication is a query to be handled by the communication agent based on a comparison of the confidence score to a confidence threshold.

12. The computing system of claim 11, wherein the large language model is further trained based on the comparison of the confidence score to the confidence threshold.

13. The computing system of claim 8, wherein generating the response to the electronic communication comprises
determining, using the large language model, a level of detail to provide in the response based on an identity of the second user, the electronic communication, and the one or more profile settings.

14. The computing system of claim 14, wherein the level of detail is determined in part based on a trust factor associated with the identity of the second user.

15. A non-transitory, computer-readable medium comprising
a communication agent associated with a first user, the communication agent comprising a large language model and one or more profile settings associated with the first user; and
instructions that, when executed by an electronic processor, cause the electronic processor to perform operations, the operations comprising:
receiving an electronic communication from a second user;
determining, using the large language model of the communication agent, whether or not to respond to the electronic communication using the communication agent;
in response to determining to not respond to the electronic communication
determining, based on the electronic communication and the one or more profile settings for the user, an action to take for the electronic communication; and
generating instructions to perform the determined action.

16. The non-transitory, computer-readable medium of claim 15, wherein determining whether or not to respond to the electronic communication using the communication agent comprises
providing the one or more profile settings and the electronic communication to the large language model of the communication agent;
determining an intent of the electronic communication using the large language model based on the one or more profile settings and the electronic communication; and
determining if the electronic communication from the second user is a query to be handled by the communication agent based on the determined intent.

17. The non-transitory, computer-readable medium of claim 16, wherein determining whether or not to respond to the electronic communication comprises
determining to not respond to the electronic communication when the electronic communication is determined to not be a query to be handled by the communication agent.

18. The non-transitory, computer-readable medium of claim 17, wherein determining if the electronic communication from the second user is a query to be handled by the communication agent further comprises
determining a confidence score for response based on the electronic communication, the one or more profile settings, and the determined intent; and
determining the electronic communication is a query to be handled by the communication agent based on a comparison of the confidence score to a confidence threshold.

19. The non-transitory, computer-readable medium of claim 15, wherein determining an action to take for the electronic communication comprises
determining, based on the electronic communication and the one or more profile settings, to forward the electronic communication to an electronic communication address associated with the first user.

20. The non-transitory, computer-readable medium of claim 15, wherein determining an action to take for the electronic communication comprises
determining, based on the electronic communication and the one or more profile settings, that the electronic communication includes information to be buffered;
storing the electronic communication in an information buffer; and
in response to the information buffer meeting a summary condition,
generating a summary message describing information stored in the information buffer; and
transmitting the summary message to an electronic communication address associated with the first user.
